(19) United States
(12) Patent Application Publication
(10) Pub. No.: US 2024/0320026 A1
(43) Pub. Date: Sep. 26, 2024

(54) DYNAMIC BUFFER LIMIT CONFIGURATION OF MONITORING AGENTS

(71) Applicant: VMware LLC, Palo Alto, CA (US)

(72) Inventors: ABHISHEK SINGH, Bangalore (IN); Vinothkumar D., Tamil Nadu (IN); Atreyee Bhaduri, Bangalore (IN); Bhuvaneswari Addanki, Bangalore (IN); Akansha Srivastava, Lucknow (IN)

(21) Appl. No.: 18/195,399

(22) Filed: May 10, 2023

(30) Foreign Application Priority Data
Mar. 22, 2023 (IN) 202341020046

(51) Int. Cl. G06F 9/455

(52) U.S. Cl. CPC G06F 9/45558; G06F 2009/4557; G06F 2009/45591

(57) ABSTRACT

An example system may include a first endpoint and a second endpoint executing a remote collector to monitor the first endpoint. The remote collector may include a buffer limit configuration unit to receive a request to install a monitoring agent on the first endpoint. The request may include an operating system type. Further, the buffer limit configuration unit may determine a first predefined buffer limit corresponding to the operating system type. Furthermore, the remote collector may include an installation unit to install the monitoring agent with configuration data on the first endpoint. The configuration data may specify a configuration for the monitoring agent to monitor an operating system executing in the first endpoint and the first predefined buffer limit as a buffer limit for the monitoring agent. Furthermore, the installation unit may enable the monitoring agent to monitor the operating system based on the configuration data with the buffer limit.

### RELATED APPLICATIONS

Benefit is claimed under 35 U.S.C. 119(a)-(d) to Foreign application Ser. No. 20/234,1020046 filed in India entitled “DYNAMIC BUFFER LIMIT CONFIGURATION OF MONITORING AGENTS”, on Mar. 22, 2023, by VMware, Inc., which is herein incorporated in its entirety by reference for all purposes

The present application (Attorney Docket No. 1282.02) is related in subject matter to U.S. patent application Ser. No. 18/195,394 (Attorney Docket No. 1282.01), which is incorporated herein by reference.

### TECHNICAL FIELD

The present disclosure relates to computing environments, and more particularly to methods, techniques, and systems for configuring buffer limit of monitoring agents for optimized resource utilization.

### BACKGROUND

In application/operating system (OS) monitoring environments, a management node that runs a monitoring tool (i.e., a monitoring application) may communicate with multiple endpoints to monitor the endpoints. For example, an endpoint may be implemented in a physical computing environment, a virtual computing environment, or a cloud computing environment. Further, the endpoints may execute different applications via virtual machines (VMs), physical host computing systems, containers, and the like. In such environments, the management node may communicate with the endpoints to collect performance data/metrics (e.g., application metrics, operating system metrics, and the like) from underlying operating system and/or services on the endpoints for storage and performance analysis (e.g., to detect and diagnose issues). Performance monitoring of such endpoints can be done using an agent-based or agentless approach. Agent-based monitoring has the advantages of being precise, granular, and having a large number of metrics. An example monitoring agent may be Telegraf™, an open-source tool that runs on the endpoints (e.g., VMs), collects metrics, and pushes the metrics to a remote collector (e.g., Cloud Proxy (CP)).

### BRIEF DESCRIPTION OF THE DRAWINGS

FIG. 1 is a block diagram of an example system, depicting a buffer limit configuration unit to enable a monitoring agent to monitor a first endpoint based on configuration data with a buffer limit;

FIG. 2A shows a block diagram of an example data center, depicting a buffer limit configuration unit to enable a monitoring agent to monitor an endpoint based on configuration data with a buffer limit;

FIG. 2B shows a block diagram of an example configuration master, depicting calculation of a buffer limit;

FIG. 3 is a sequence diagram illustrating an example sequence of events to enable a monitoring application to monitor an endpoint based on updated configuration data with a buffer limit;

FIG. 4 is a flow diagram illustrating an example method for updating configuration data with a buffer limit of a monitoring agent for monitoring an endpoint; and

FIG. 5 is a block diagram of an example second endpoint including non-transitory computer-readable storage medium storing instructions to enable a monitoring agent to monitor a first endpoint based on an updated configuration data.

The drawings described herein are for illustrative purposes and are not intended to limit the scope of the present subject matter in any way.

### DETAILED DESCRIPTION

Examples described herein may provide an enhanced computer-based and/or network-based method, technique, and system to configure a buffer limit (e.g., a buffer size) of monitoring agents running in endpoints of a computing environment. The

paragraphs to present an overview of the computing environment, existing methods to monitor endpoints, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

Further, performance monitoring of the endpoints has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware Wavefront™, Grafana, and the like.

In some examples, the endpoints may include monitoring agents (e.g., Telegraf™, Collectd, Micrometer, and the like) to collect the performance metrics from the respective endpoints and provide, via a network, the collected performance metrics to a remote collector (e.g., a Cloud Proxy (CP)). For example, the monitoring agent such as Telegraf™ agent running on the endpoints may collect metrics and publish them to multiple metric receivers. An example Apache HTTPD server serves as the metrics receiver in the CP. For example, the Apache HTTPD server running in the CP may listen on a specific location directive on port 443 to receive the metrics from the Telegraf™ agent.

Further, the remote collector may receive the performance metrics from the monitoring agents and transmit the performance metrics to a monitoring tool or a monitoring application for metric analysis. A remote collector may refer to a service/program that is installed in an additional cluster node (e.g., an endpoint (a virtual machine)). The remote collector may allow the monitoring application (e.g., vROps Manager) to gather objects into the remote collector's inventory for monitoring purposes. The remote collector collects the data from the endpoints and then forward the data to an application monitoring server that executes the monitoring application. For example, remote collectors may be deployed at remote location sites while the monitoring tool may be deployed at a primary location. Furthermore, the monitoring application may receive the performance metrics, analyse the received performance metrics, and display the analysis in a form of dashboards, for instance. The displayed analysis may facilitate in visualizing the performance metrics and diagnose a root cause of issues, if any.

Furthermore, the monitoring agent such as Telegraf™ may be a plugin-based agent, i.e., plugins for collecting and publishing metrics. Input plugins may be responsible for collecting metrics of operating system and/or specific applications running in the endpoints and the output plugins may be responsible for publishing metrics to the remote collector (e.g., a HTTPD server). The behavior of the metrics collection, the input and output plugins may be customized using a configuration file of the monitoring agent. Some of the configurations of the configuration file may include:
Interval-Periodic data collection interval
Buffer limit-For failed writes, the monitoring agent caches metrics for each output and flushes the buffer on a successful write. When the buffer fills, the oldest metrics may be dropped first. The buffer only fills when writes to the output plugin(s) fail.
Flush interval-Default flushing interval for all the output plugins. The flush interval is configured less than the periodic data collection interval. For example, a maximum flush interval may include a sum of the flush interval and flush jitter.
Output plugins (e.g., [[outputs.http]])—Configuration for posting metrics to the HTTPD server.
Input plugins (e.g., [[inputs.cpu]], [[inputs.mem]], [[inputs.net]], [[inputs.swap]], [[inputs.disk]], [[inputs.nginx]], [[inputs.mongodb]])—Configuration to collect the metrics of the operating system and specific applications.

The metrics from all the configured input plugins may be collected and stored in the buffer at regular intervals. Further, the metrics in the buffer may be posted to the output plugins at every “flush interval” time. When writing the metrics to the output plugins fails, the metrics collected may be persisted in the buffer until a successful write happens. In this example, for failed writes, the monitoring agent may cache metrics for each output in the buffer and flush the buffer on a successful write. When the buffer gets full, the oldest metrics on the buffer may be dropped.

In some examples, consider that the data center is significantly huge, and the monitoring agent is installed on all the endpoints in the data center to collect the operating system metrics and metrics of applications running in the endpoints. In this example, if the remote collector is down or not reachable from the monitoring agent, then metrics collected at every collection interval on each endpoint may be stored in a respective buffer until the monitoring agent is able to successfully post the metrics to the remote collector. In some existing methods, the buffer size/limit may be configured as a constant value. For example, the value of the buffer limit is 10,000. i.e., a maximum of 10,000 metrics can be stored in the buffer.

The number of metrics collected for each endpoint may be determined by the factors such as hardware configurations (e.g., a number of central processing units (CPUs), disks, network interface cards (NICs)), number of applications running, instances of applications, software configurations, and the like. Each endpoint may have distinct factors that result in a different number of metrics. Thus, having a common “buffer limit” value for all the monitoring agents may not be feasible as the “buffer limit” value can be greater or lesser than the actual number of metrics that will be collected in that endpoint. For example, having a higher value may result in denial-of-service (DOS) attack at the receiver, while having a lower value may result in not collecting all the data from a single collection cycle due to a lack of buffer space. When the DoS occurs due to significantly large size buffer at the monitoring agent side, then there will be a downtime of monitoring critical virtual infrastructure (e.g., the endpoint), which may be not acceptable.

Some existing methods may hardcode the “buffer limit” value to some average number to overcome the above-mentioned issue. However, hardcoding the “buffer limit” value to some average number may result in metric being missed and/or DoS. In another existing method, the buffer limit on the monitoring agents may be manually updated and the service may be restarted. However, manually updating the buffer limit may be a tedious and time-consuming process, particularly in significantly large computing environments. Some other existing methods may involve uninstalling the monitoring agent on the endpoints and reinstall when the DoS happens. However, reinstalling the monitoring agent might lose the state of input plugin configurations that are already done. Hence, the plugin activation has to be redone. In yet another existing method, reconfiguring the HTTPD server that collects metrics in the remote collector might help in avoiding the DoS. However, reconfiguring may require significantly more resources (e.g., RAM, CPU, Worker Threads, and the like) for the HTTPD server to accept and process all the requests. Extending the resource for recovering from DoS may not be feasible solution as the same problem might occur again if the environment is exponentially bigger and/or the collection interval is reduced.

Further, for each input plugin, one hypertext transfer protocol (HTTP) message may be posted. If the number of metrics per plugin is significantly huge, the metrics may be divided into multiple HTTP messages. For example, consider that monitoring agent on each endpoint is configured with approximately 7 input plugins (e.g., 5 for operating system metrics and 2 for any application running in the endpoint). Further, for each collection cycle metric to be published to the remote collector, 7 HTTP POST calls may be made to the remote collector (e.g., cloud proxy's (CP's) port 443) on the listening location endpoint. Consider that the number of metrics collected in one collection cycle is 100 (approximately). If the remote collector is down for more than 20 collection cycles, then the buffers of the monitoring agents may be filled and start dropping oldest messages. Thus, there may be 20×7=140 HTTP POST calls waiting on the buffer. Once the remote collector is back online, then all the monitoring agents may be trying to flush all the POST calls to the remote collector, which spikes the CPU load to >90%, for instance. As a result, the HTTP server may face data forwarding problems, gaps in metrics collection, failure of REST API calls from the adapter to the cluster, and so on.

For example, the number of HTTP requests after the remote collector recovers from the failure may be high due to metrics of 20+ collection cycles being buffered on all the monitoring agents. At the receiving end (i.e., at the remote collector), the metrics collected may be kept on the server-side buffer. At every parsing interval (e.g., say 5 mins), the metrics buffered may be parsed and updated at replica nodes. At any parsing cycle, only the latest collection metric may be parsed and the rest may be dropped. Thus, out of the 20+ collection cycle metrics that are buffered at the monitoring agent and posted to the remote collector, only one collection cycle data may be parsed and updated to the time series database. Hence, the aforementioned problem can be avoided by sending only the latest collection cycle metric data from the monitoring agent. To achieve this, the buffer limit of the monitoring agent should be configured with a number that will hold only one collection cycle data. Such a configuration may make the monitoring agent to hold only latest collection cycle metrics. Thus, even if the remote collector is down for a few days, on recovering, a significantly limited number of HTTP requests may be made.

Examples described herein may provide a buffer limit configuration unit to dynamically configure a buffer limit for a monitoring agent to monitor an endpoint. In an example, a system may include a first endpoint and a second endpoint executing a remote collector. The remote collector may monitor the first endpoint and send monitored information to a monitoring application. The remote collector may include a buffer limit configuration unit and an installation unit. During operation, the buffer limit configuration unit may receive a request to install a monitoring agent on the first endpoint. The request may include an operating system type. Further, the buffer limit configuration unit may determine a first predefined buffer limit corresponding to the operating system type. Furthermore, the installation unit may install the monitoring agent with configuration data on the first endpoint. The configuration data may specify a configuration for the monitoring agent to monitor an operating system executing in the first endpoint and the first predefined buffer limit as a buffer limit for the monitoring agent. Furthermore, the buffer limit configuration unit may enable the monitoring agent to monitor the operating system based on the configuration data with the buffer limit.

Further, in response to receiving a request to monitor an application running in the first endpoint, the buffer limit configuration unit may determine a category of the application and determine a second predefined buffer limit associated with the category of the application. Furthermore, the buffer limit configuration unit may update the configuration data in the first endpoint to add a configuration for the monitoring agent to monitor the application running in the first endpoint and update the buffer limit of the monitoring agent to add the second predefined buffer limit to the first predefined buffer limit. Upon updating the configuration data, the buffer limit configuration unit may enable the monitoring agent to monitor the operating system and the application based on the updated configuration data.

Thus, the examples described herein may provide an ability to update the buffer limit at any time during the monitoring agent's lifetime, optimize resource utilization on the endpoint being monitored, and ensure that there is no DoS threat. Also, examples described herein may dynamically configure a unique buffer limit for each endpoint, which can reduce the network traffic.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

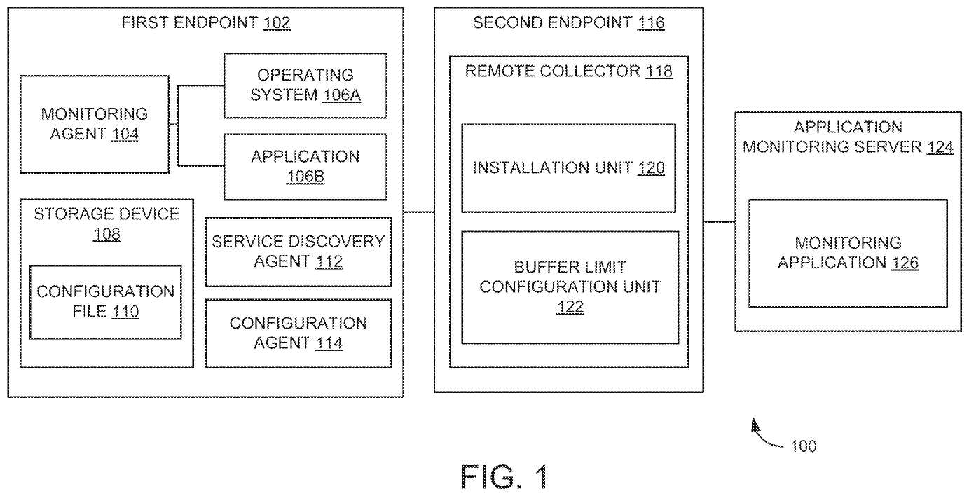

Referring now to the figures, FIG. 1 is a block diagram of an example system 100, depicting a buffer limit configuration unit 122 to configure a buffer limit of a monitoring agent 104 for monitoring an endpoint (e.g., a first endpoint 102). Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 may be a data center that includes multiple endpoints (e.g., a first endpoint 102). In an example, an endpoint may include, but not limited to, a virtual machine, a physical host computing system, a container, a software defined data center (SDDC), or any other computing instance that executes different applications. For example, the endpoint can be deployed either in an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, first endpoint 102 may include monitoring agent 104 to monitor applications or services or programs running in first endpoint 102. In an example, monitoring agent 104 may be installed in first endpoint 102 to fetch the metrics from various components of first endpoint 102. For example, monitoring agent 104 may real-time monitor first endpoint 102 to collect the metrics (e.g., telemetry data) associated with an application or an operating system running in first endpoint 102. Example monitoring agent 104 may be Telegraf agent, Collectd agent, or the like. Example metrics may include performance metric values associated with at least one of central processing unit (CPU), memory, storage, graphics, network traffic, applications, or the like.

Further, system 100 may include a second endpoint 116 in communication with first endpoint 102. In an example, second endpoint 116 may include a virtual machine, a container, or a physical computing system. In some examples, second endpoint 116 may execute a remote collector 118 (e.g., a cloud proxy (CP), an application remote collector (ARC), or the like) to monitor plurality of endpoints (e.g., first endpoint 102) in the data center. Further, remote collector 118 may send monitored information associated with first endpoint 102 to a monitoring application 126. For example, remote collector 118 may receive the metrics (e.g., performance metrics) of first endpoint 102 from monitoring agent 104. Further, remote collector 118 may transmit the received metrics to monitoring application 126 running in an application monitoring server 124 to analyse the received metrics.

Furthermore, second endpoint 116 may be communicatively connected to application monitoring server 124 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, remote collector 118 may include buffer limit configuration unit 122 and an installation unit 120. During operation, buffer limit configuration unit 122 may receive a request to install monitoring agent 104 on first endpoint 102. In an example, the request may include an operating system type (e.g., Windows®, Linux®, Apple Mac®, and the like).

Further, buffer limit configuration unit 122 may determine a first predefined buffer limit corresponding to the operating system type. For example, each operating system may require a different predefined buffer limit, for instance, Windows® may need a buffer limit of 2000 metrics, Linux® may need a buffer limit of 1500 metrics, and the like. Furthermore, installation unit 120 may install monitoring agent 104 with configuration data on first endpoint 102. The configuration data may specify a configuration for monitoring agent 104 to monitor an operating system executing in first endpoint 102 and the first predefined buffer limit as a buffer limit for monitoring agent 104. In an example, the configuration data may be stored in a configuration file 110, which may be stored in a storage device 108.

Furthermore, buffer limit configuration unit 122 may enable monitoring agent 104 to monitor the operating system based on the configuration data with the buffer limit. In this example, buffer limit configuration unit 122 may start monitoring agent 104 to enable monitoring of the operating system. Further, buffer limit configuration unit 122 may receive a request to monitor an application 106B running in first endpoint 102. In response to receiving the request, buffer limit configuration unit 122 may determine a category of application 106B. In an example, application 106B belongs to one of a set of categories (e.g., large, medium, and small), with each category is associated with a different predefined buffer limit.

Further, buffer limit configuration unit 122 may determine a second predefined buffer limit associated with the category of application 106B. For example, the second predefined buffer limit associated with the category (e.g., medium) may be determined as 1500 metrics. Furthermore, buffer limit configuration unit 122 may update the configuration data in first endpoint 102 to add a configuration for monitoring agent 104 to monitor application 106B running in first endpoint 102 and update the buffer limit of monitoring agent 104 to add the second predefined buffer limit to the first predefined buffer limit. In this example, the buffer limit of monitoring agent 104 may be updated to add 2000 metrics (e.g., for Windows® operating system) and 1500 metrics (e.g., for the category of application 106B). Further, buffer limit configuration unit 122 may enable monitoring agent 104 to monitor operating system 106A and application 106B based on the updated configuration data with the updated buffer limit.

In another example, buffer limit configuration unit 122 may receive a request to disable monitoring of application 106B. In response to receiving the request to disable monitoring of application 106B, buffer limit configuration unit 122 may determine the category of application 106B. Further, buffer limit configuration unit 122 may determine the second predefined buffer limit associated with the category of application 106B. Furthermore, buffer limit configuration unit 122 may reupdate the configuration data in first endpoint 102 to remove the configuration for monitoring agent 104 to disable monitoring of application 106B and update the buffer limit of monitoring agent 104 to deduct the second predefined buffer limit from the updated buffer limit. In this example, the buffer limit of monitoring agent 104 may be updated to deduct 1500 metrics (e.g., for the category of application 106B) from the updated buffer limit of 3500 metrics. Further, buffer limit configuration unit 122 may enable monitoring agent 104 to monitor operating system 106A based on the reupdated configuration data. Thus, buffer limit configuration unit 122 described herein may have an ability to dynamically update the buffer limit of monitoring agent 104 based on a request to enable or disable monitoring of the applications.

In an example, installation unit 120 may install a service discovery agent 112 in first endpoint 102. Service discovery agent 112 may discover a plurality of applications running in first endpoint 102 and send a list of the discovered applications to remote collector 118. In another example, installation unit 120 may install a configuration agent 114 on first endpoint 102. Configuration agent 114 may receive command from a configuration master of remote collector 118 and execute the command to update the configuration data including the buffer limit for enabling monitoring of application 106B or disabling monitoring of application 106B.

In some examples, buffer limit configuration unit 122 may render the list of the discovered applications on a user interface of monitoring application 126. Further, buffer limit configuration unit 122 may receive, via the user interface of monitoring application 126, a request to enable monitoring of the application from the list of discovered applications. In response to receiving the request, buffer limit configuration unit 122 may determine a category of the application. Furthermore, buffer limit configuration unit 122 may determine a second predefined buffer limit associated with the category of the application. Further, buffer limit configuration unit 122 may send a first command including the second predefined buffer limit to configuration agent 114 to enable monitoring of the application.

In this example, configuration agent 114 may execute the first command to update the configuration data to add an input plugin configuration to configuration file 110 of monitoring agent 104 for monitoring the application and update the buffer limit to add the second predefined buffer limit to the first predefined buffer limit. Further, configuration agent 114 may restart monitoring agent 104 to enable monitoring agent 104 to monitor operating system 106A and application 106B based on the updated configuration data.

Further during operation, buffer limit configuration unit 122 may receive, via the user interface of monitoring application 126, a request to disable monitoring of application 106B. In response to receiving the request, configuration agent 114 may determine the category of application 106B. Further, configuration agent 114 may determine the second predefined buffer limit associated with the category of application 106B. Furthermore, configuration agent 114 may send a second command including the second predefined buffer limit to configuration agent 114 to disable monitoring of application 106B.

In this example, configuration agent 114 may execute the second command to reupdate the configuration data to remove the input plugin configuration from configuration file 110 of monitoring agent 104 to disable the monitoring of application 106B and update the buffer limit to deduct the second predefined buffer limit from the updated buffer limit. Further, configuration agent 114 may restart monitoring agent 104 to enable monitoring agent 104 to monitor first endpoint 102 based on the reupdated configuration data.

In some examples, the functionalities described in FIG. 1, in relation to instructions to implement functions of monitoring agent 104, service discovery agent 112, configuration agent 114, buffer limit configuration unit 122, installation unit 120, and any additional instructions described herein in relation to the storage medium, may be implemented as engines or modules including any combination of hardware and programming to implement the functionalities of the modules or engines described herein. The functions of monitoring agent 104, service discovery agent 112, configuration agent 114, installation unit 120, and buffer limit configuration unit 122 may also be implemented by a respective processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., endpoints), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

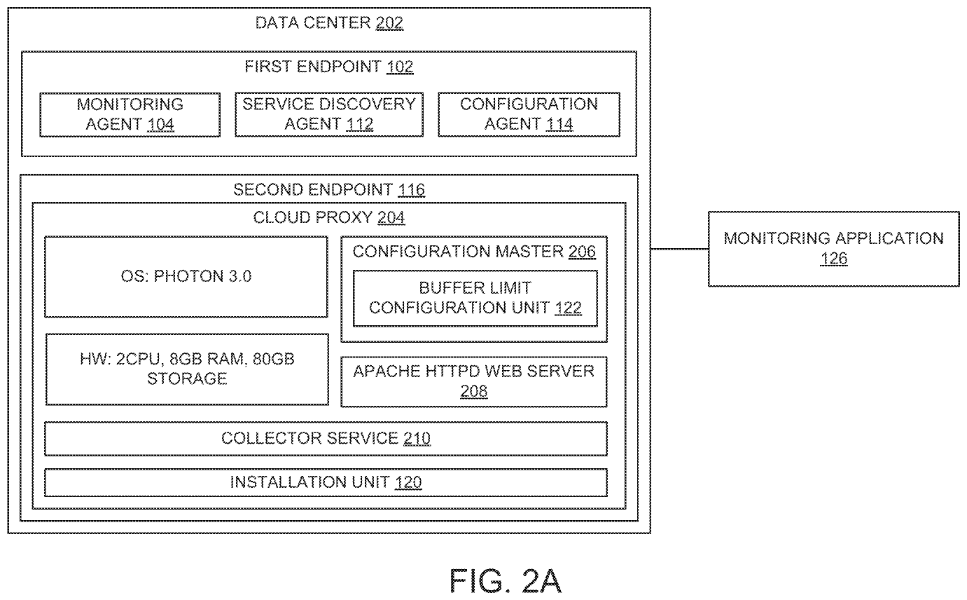

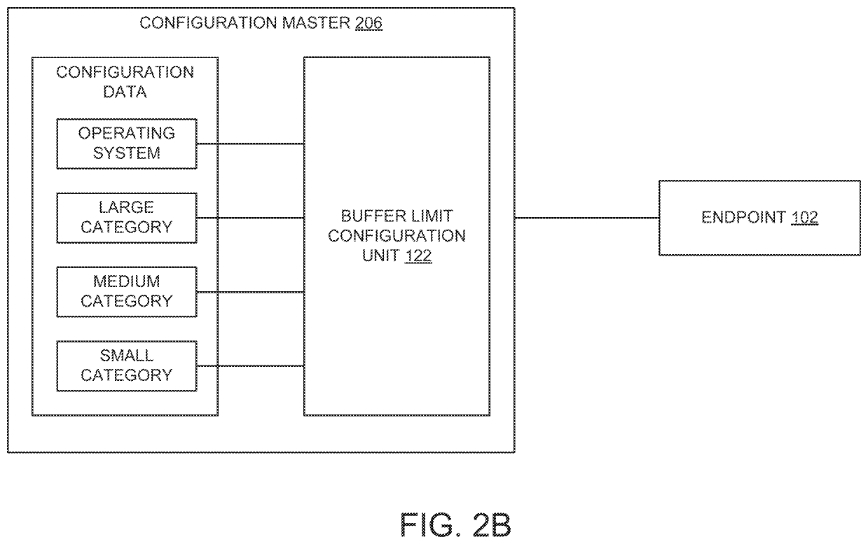

FIG. 2A shows a block diagram of an example data center 202, depicting a buffer limit configuration unit 122 to configure a buffer limit of a monitoring agent 104 to monitor an endpoint (e.g., first endpoint 102). For example, similarly named elements of FIG. 2A may be similar in structure and/or function to elements described with respect to FIG. 1. In the example shown in FIG. 2A, data center 202 includes first endpoint 102 and second endpoint 116. Further, data center 202 may be communicatively connected to monitoring application 126.

Example first endpoint 102 may include monitoring agent 104 (e.g., a Telegraf agent) to collect metrics, a service discovery agent 112 (e.g., a UCP minion agent) for service discovery, and a configuration agent 114 (e.g., a Salt minion) for control actions.

Example second endpoint 116 may include a remote collector. An example remote collector can be a cloud proxy 204, which may run on Photon operating system version 3.0, a processor (e.g., 2CPU), and a storage (e.g., 80 GB storage). In some examples, the remote collector may include a data plane and a control plane. For example, the data plane may be provided by an Apache HTTPD web server 208 and the control plane may be provided via a Salt master (e.g., configuration master 206 running in second endpoint 116). Furthermore, cloud proxy 204 may include a collector service 210 to collect metrics from first endpoint 102.

In another example, the remote collector may be an application remote collector (ARC), which runs on Photon operating system version 1.0. In this example, the data plane may be provided by an EMQTT message broker (e.g., via MQTT Protocol) and the control plane may be provided via the Salt master.

In some examples, the remote collector may use OpenSSL certificates and keys to secure endpoint communications (e.g., metric communications). Further, the remote collector may use Salt for control plane activities on first endpoint 102. The Salt may use a server-agent communication model, where a server component is referred to as the Salt master (i.e., configuration master 206) and an agent is referred to as the Salt minion (i.e., configuration agent 114). The Salt master and the Salt minion may secure communication through Salt master keys and Salt minion keys generated at second endpoint 116 on which the remote collector is resided. A Salt state may be applied from the Salt master to the Salt minion to apply control commands on first endpoint 102. Further, second endpoint 116 may include a buffer limit configuration unit 122 in configuration master 206.

During operation, installation unit 120 may install monitoring agent 104 on first endpoint 102 along with input plugin configuration required for operating system metrics collection and calculated buffer limit. The process of calculating the buffer limit is described in FIG. 2B. Further, monitoring of first endpoint 102 may be initiated as a service. In an example, configuration agent 114 (e.g., the salt minion) and service discovery agent 112 (e.g., the UCP minion) may be installed during the installation of monitoring agent 104.

Further, service discovery agent 112 may discover a curated list of services and present the curated list of services on a user interface associated with monitoring application 126. Further, on users input for plugin activation request, buffer limit configuration unit 122 may recalculate the buffer limit and may update the configuration data of monitoring agent 104 with the recalculated buffer limit and to add a new plugin. Upon recalculating the buffer limit, monitoring agent 104 may be restarted. In an example, the buffer limit may be recalculated for any new application or service that has to be monitored in first endpoint 102.

In an example, to stop monitoring of an application being executed in first endpoint 102, the respective input plugin content can be removed from the configuration of monitoring agent 104 using configuration master 206. Upon disabling the monitoring of the application or service, the buffer limit may be modified, the configuration of monitoring agent 104 may be updated, and monitoring agent 104 may be restarted. Thus, examples described herein may provide buffer limit configuration unit 122 to dynamically change the metric buffer limit to a defined number of metrics that will be collected in a cycle on every reconfiguration of the monitoring agent 104 (e.g., addition or deletion of the input plugins).

FIG. 2B shows a block diagram of an example configuration master (e.g., configuration master 206 of FIG. 2A), depicting calculation of a buffer limit. For example, similarly named elements of FIG. 2B may be similar in structure and/or function to elements described with respect to FIG. 2A. In an example, an initial buffer limit may be determined based on a type of an operating system at the time of installation of the monitoring agent. For example, in case of Linux and Windows, the buffer limit may be different.

Further, each curated application may be broken down into one of three categories (e.g., large, medium, and small) as shown in FIG. 2B. In this example, each category may have a predefined buffer limit. In an example, the buffer limit may be increased when a plugin is activated depending on the category of application (e.g., the existing buffer limit plus the application-category-specific buffer limit). In another example, the buffer limit may be decreased when a plugin is deactivated depending on the category of application (e.g., the existing buffer limit minus the application category-specific buffer limit). For example, consider the monitoring agent may be installed with a MongoDB application (e.g., assuming the category of the application as medium) on a Linux virtual machine. Initially, the configuration may specify the buffer limit for Linux. Further, the buffer limit may be increased by the buffer limit specific to the medium category if the MongoDB plugin is enabled. Furthermore, when the plugin is deactivated, the buffer limit will be decreased by the medium category specific buffer limit.

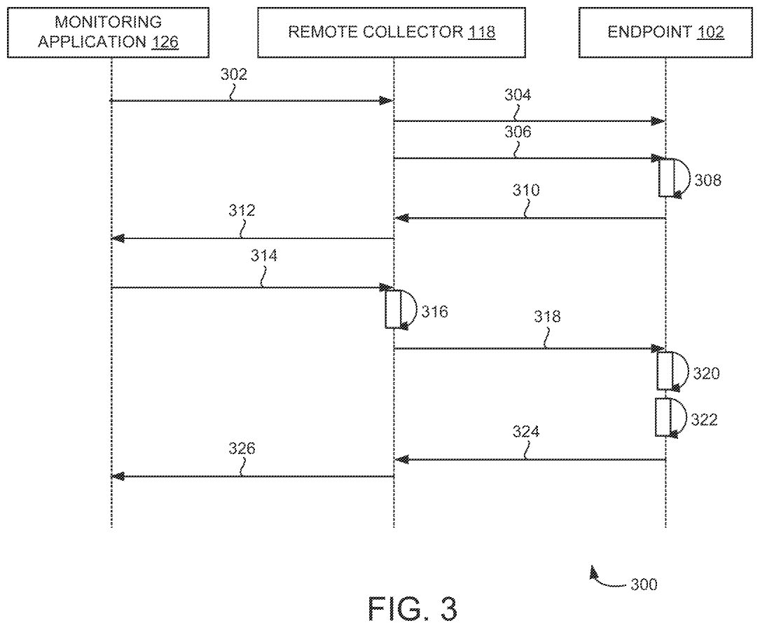

FIG. 3 is a sequence diagram 300 illustrating an example sequence of events to configure a buffer limit of a monitoring agent to monitor an endpoint (e.g., first endpoint 102 of FIG. 1). Sequence diagram 300 may represent the interactions and the operations involved in updating the configuration data with the buffer limit to monitor endpoint 102. FIG. 3 illustrates process objects including a monitoring application 126, a remote collector (e.g., remote collector 118 of FIG. 1), and endpoint 102 along with their respective vertical lines originating from them. The vertical lines of monitoring application 126, remote collector 118, and endpoint 102 may represent the processes that may exist simultaneously. The horizontal arrows (e.g., 302, 304, 306, 310, 312, 314, 318, 324, and 326) may represent the data flow steps between the vertical lines originating from their respective process objects (for e.g., monitoring application 126, remote collector 118, and endpoint 102). Further, activation boxes (e.g., 308, 316, 320, and 322) between the horizontal arrows may represent the process that is being performed in the respective process object.

At 302, monitoring application 126 may trigger installation of a monitoring agent (e.g., a Telegraf agent), for instance, from a user interface, an application programing interface (API), or a script. Upon triggering the installation, at 304, remote collector 118 may install the monitoring agent with input plugins of endpoint 102 to collect operating system metrics and with a default metric buffer limit value.

At 306, remote collector 118 may install a configuration agent (e.g., a salt minion) and a service discovery agent (e.g., a UCP minion) on endpoint 102. At 308, the monitoring agent in endpoint 102 may be started to monitor and send operating system metrics to remote collector 118. At 310, remote collector 118 may collect service discovery metrics specifying a curated list of applications running in endpoint 102 from the service discovery agent running in endpoint 102.

At 312, the curated list of applications discovered against endpoint 102 may be presented in a user interface of monitoring application 126. At 314, a plugin activation/deactivation action may be triggered from the user interface to enable/disable monitoring of an application of the curated list of applications. At 316, remote collector 118 may calculate the buffer limit value depending on the category of application activated/deactivated. For example, the buffer limit is raised when a plugin is activated, depending on the category of application activated (i.e., the existing buffer limit plus the application category-specific buffer limit). The buffer limit is decreased when a plugin is deactivated, depending on the category of application deactivated (i.e., the existing buffer limit minus the application category-specific buffer limit)

At 318, a salt state action may be initiated to add/delete monitoring agent's plugin configurations and update the buffer limit of the monitoring agent to enable/disable monitoring of the application. At 320, endpoint 102 may execute the salt state action to update the buffer limit and application content in the configuration data of the monitoring agent. Upon updating the buffer limit, the monitoring agent may be restarted, at 322, to enable the monitoring agent to collect the operating system and/application metrics based on the configuration data with the updated buffer limit.

At 324, remote collector 118 may collect the metrics from the monitoring agent based on the plugin configurations. At 326, remote collector 118 may update monitoring application 126 with the collected metrics.

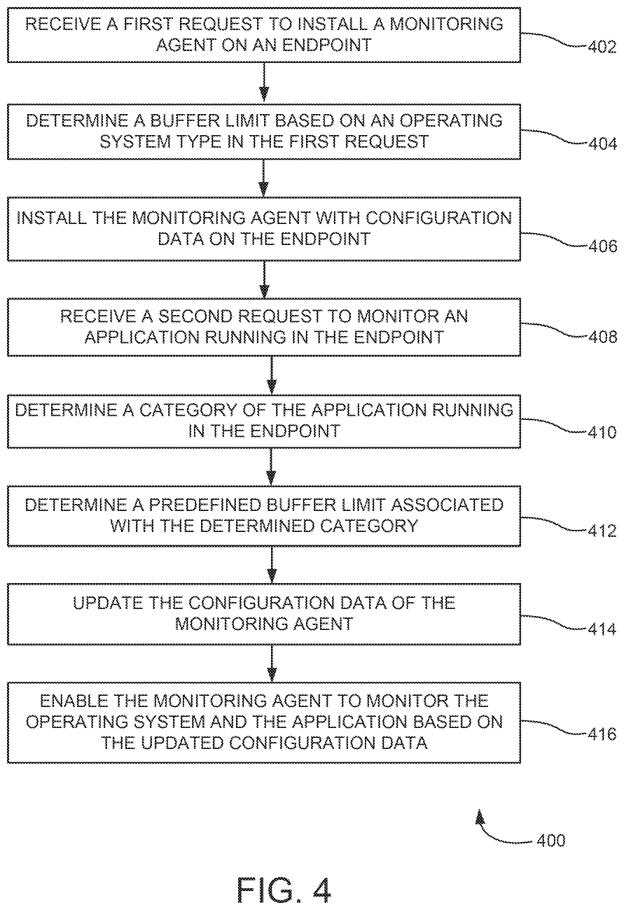

FIG. 4 is a flow diagram illustrating an example method 400 for dynamically updating a buffer limit of a monitoring agent. In an example, method 400 may be performed by a remote collector executing on a management node. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, a first request to install a monitoring agent on an endpoint may be received. In an example, the first request may include an operating system type. At 404, a buffer limit may be determined based on the operating system type. At 406, the monitoring agent may be installed with configuration data on the endpoint. The configuration data may specify a configuration to monitor an operating system executing in the endpoint and the buffer limit for the monitoring agent. In an example, upon installing the monitoring agent on the endpoint, the monitoring agent may be executed to enable monitoring of the operating system based on the configuration data with the buffer limit.

At 408, a second request to monitor an application running in the endpoint may be received. In an example, receiving the second request may include receiving, via a service discovery agent running on the endpoint, a list of applications running in the endpoint. The service discovery agent may discover the plurality of services running in the endpoint. Further, the list of the discovered applications may be rendered on a user interface of a monitoring application. Furthermore, the second request to monitor the application from the discovered applications may be received via the user interface of the monitoring application.

At 410, a category of the application running in the endpoint may be determined. At 412, a predefined buffer limit associated with the determined category may be determined. At 414, the configuration data of the monitoring agent may be updated to add a configuration to enable monitoring of the application and update the buffer limit to add the predefined buffer limit. In an example, updating the configuration data may include initiating, via a configuration agent running in the endpoint, a command to add an input plugin configuration to a configuration file of the monitoring agent for enabling monitoring of the application and update the buffer limit to add the predefined buffer limit. At 416, the monitoring agent may be enabled to monitor the operating system and the application based on the updated configuration data.

Further, example method 400 may include receiving a third request to disable monitoring of the application. Upon receiving the third request, the category of the application running in the endpoint may be determined. Further, the predefined buffer limit associated with the determined category may be determined. Furthermore, the configuration data of the monitoring agent may be reupdated to remove the configuration to disable monitoring of the application and update the buffer limit to deduct the predefined buffer limit. Further, the monitoring agent may be enabled to monitor the operating system based on the reupdated configuration data.

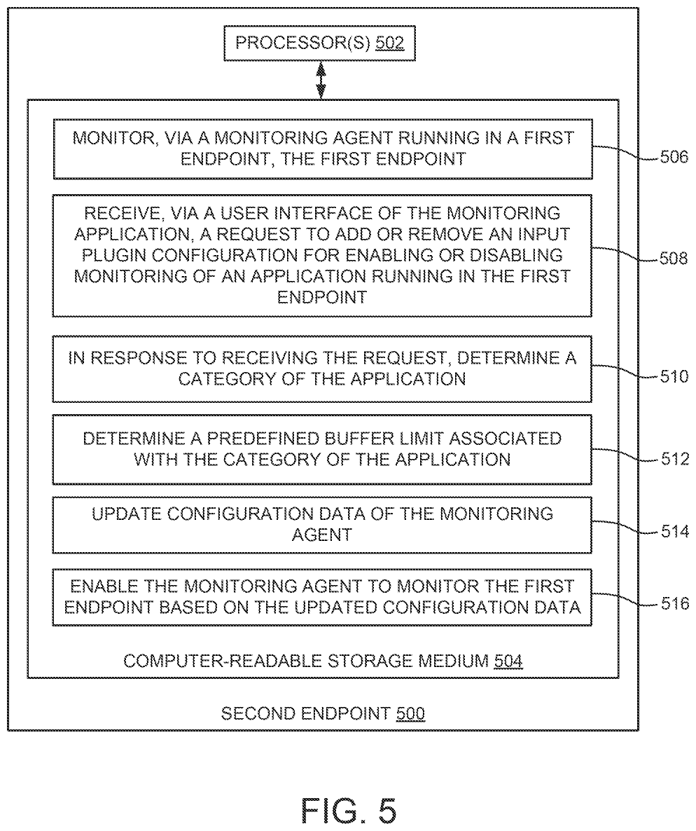

FIG. 5 is a block diagram of an example second endpoint 500 including non-transitory computer-readable storage medium 504 storing instructions to dynamically update a buffer limit of a monitoring agent. Second endpoint 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to second endpoint 500.

Computer-readable storage medium 504 may store instructions 506, 508, 510, 512, 514, and 516. Instructions 506 may be executed by processor 502 to monitor, via a monitoring agent running in a first endpoint, the first endpoint and send monitored information to a monitoring application. Instructions 508 may be executed by processor 502 to receive, via a user interface of the monitoring application, a request to add or remove an input plugin configuration for enabling or disabling monitoring of an application running in the first endpoint.

In response to receiving the request, instructions 510 may be executed by processor 502 to determine a category of the application. In an example, instructions 510 to determine the category of the application may include instructions to receive, via a service discovery agent running in the first endpoint, a plurality of applications running in the first endpoint. For example, each application may belong to one of a set of categories and each category may be associated with a different predefined buffer limit. Further, a request to add or remove an input plugin configuration for enabling or disabling monitoring of the application from the plurality of applications may be received via a user interface of the monitoring application. An example user interface includes a Web browser. Furthermore, upon receiving the request, the category of the application may be determined from the set of categories.

Instructions 512 may be executed by processor 502 to determine a predefined buffer limit associated with the category of the application. Instructions 514 may be executed by processor 502 to update configuration data of the monitoring agent to add or remove the input plugin configuration associated with the application and modify a buffer limit of the monitoring agent based on the predefined buffer limit. In an example, instructions 514 to update the configuration data may include instructions to update the configuration data of the monitoring agent via a configuration agent running in the first endpoint. For example, the configuration agent may receive a command from a configuration master of the second endpoint and execute the command to update the configuration data including the buffer limit for enabling or disabling monitoring of the application.

In an example, in response to the request to enable monitoring of the application, instructions 514 to update the configuration data of the monitoring agent may include instructions to update, via a configuration agent running in the first endpoint, the configuration data to add the input plugin configuration to a configuration file of the monitoring agent for monitoring the application and add the predefined buffer limit associated with the application to the buffer limit of the monitoring agent.

In another example, in response to the request to disable monitoring of the application, instructions 514 to update the configuration data of the monitoring agent may include instructions to update, via a configuration agent running in the first endpoint, the configuration data to remove the input plugin configuration from a configuration file of the monitoring agent for disabling monitoring of the application and deduct the predefined buffer limit associated with the application from the buffer limit of the monitoring agent.

Instructions 516 may be executed by processor 502 to enable the monitoring agent to monitor the first endpoint based on the updated configuration data. In an example, upon modifying the buffer limit, instructions 516 to enable the monitoring agent to monitor the first endpoint may include instructions to restart the monitoring agent to enable the monitoring agent to monitor the endpoint based on the updated configuration data.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first endpoint; and
a second endpoint executing a remote collector, wherein the remote collector is to monitor the first endpoint and send monitored information to a monitoring application, the remote collector comprising:
a buffer limit configuration unit to:
receive a request to install a monitoring agent on the first endpoint, the request comprising an operating system type; and
determine a first predefined buffer limit corresponding to the operating system type; and
an installation unit to:
install the monitoring agent with configuration data on the first endpoint, the configuration data specifying a configuration for the monitoring agent to monitor an operating system executing in the first endpoint and the first predefined buffer limit as a buffer limit for the monitoring agent; and
enable the monitoring agent to monitor the operating system based on the configuration data with the buffer limit.

2. The system of claim 1, wherein the buffer limit configuration unit is to:
receive a request to monitor an application running in the first endpoint;
in response to receiving the request, determine a category of the application;
determine a second predefined buffer limit associated with the category of the application;
update the configuration data in the first endpoint to:
add a configuration for the monitoring agent to monitor the application running in the first endpoint; and
update the buffer limit of the monitoring agent to add the second predefined buffer limit to the first predefined buffer limit; and
enable the monitoring agent to monitor the operating system and the application based on the updated configuration data.

3. The system of claim 2, wherein the buffer limit configuration unit is to:
receive a request to disable monitoring of the application;
in response to receiving the request to disable monitoring of the application, determine the category of the application;
determine the second predefined buffer limit associated with the category of the application;
reupdate the configuration data in the first endpoint to:
remove the configuration for the monitoring agent to disable monitoring of the application; and
update the buffer limit of the monitoring agent to deduct the second predefined buffer limit from the updated buffer limit; and
enable the monitoring agent to monitor the operating system based on the reupdated configuration data.

4. The system of claim 1, wherein the installation unit is to:
install a service discovery agent on the first endpoint, wherein the service discovery agent is to discover a plurality of applications running in the first endpoint and send a list of the discovered applications to the remote collector; and
install a configuration agent on the first endpoint, wherein the configuration agent is to receive command from a configuration master of the remote collector and execute the command to update the configuration data including the buffer limit for enabling monitoring of an application or disabling monitoring of the application.

5. The system of claim 4, wherein the buffer limit configuration unit is to:
render the list of the discovered applications on a user interface of the monitoring application;
receive, via the user interface of the monitoring application, a request to enable monitoring of the application from the list of discovered applications;
in response to receiving the request, determine a category of the application;
determine a second predefined buffer limit associated with the category of the application; and
send a first command including the second predefined buffer limit to the configuration agent to enable monitoring of the application.

6. The system of claim 5, wherein the configuration agent is to execute the first command to:
update the configuration data to:
add an input plugin configuration to a configuration file of the monitoring agent for monitoring the application; and
update the buffer limit to add the second predefined buffer limit to the first predefined buffer limit; and
restart the monitoring agent to enable the monitoring agent to monitor the operating system and the application based on the updated configuration data.

7. The system of claim 6, wherein the buffer limit configuration unit is to:
receive, via the user interface of the monitoring application, a request to disable monitoring of the application;
in response to receiving the request, determine the category of the application;
determine the second predefined buffer limit associated with the category of the application; and
send a second command including the second predefined buffer limit to the configuration agent to disable monitoring of the application.

8. The system of claim 7, wherein the configuration agent is to execute the second command to:
reupdate the configuration data to:
remove the input plugin configuration from the configuration file of the monitoring agent to disable the monitoring of the application; and
update the buffer limit to deduct the second predefined buffer limit from the updated buffer limit; and
restart the monitoring agent to enable the monitoring agent to monitor the first endpoint based on the reupdated configuration data.

9. The system of claim 1, wherein each of the first endpoint and the second endpoint comprises a virtual machine, a container, or a physical computing system.

10. A non-transitory computer-readable storage medium having instructions executable by a processor of a second endpoint to:
monitor, via a monitoring agent running in a first endpoint, the first endpoint and send monitored information to a monitoring application;
receive, via a user interface of the monitoring application, a request to add or remove an input plugin configuration for enabling or disabling monitoring of an application running in the first endpoint;
in response to receiving the request, determine a category of the application;
determine a predefined buffer limit associated with the category of the application;
update configuration data of the monitoring agent to:
add or remove the input plugin configuration associated with the application; and
modify a buffer limit of the monitoring agent based on the predefined buffer limit; and
enable the monitoring agent to monitor the first endpoint based on the updated configuration data.

11. The non-transitory computer-readable storage medium of claim 10, wherein instructions to update the configuration data comprise instructions to:
update the configuration data of the monitoring agent via a configuration agent running in the first endpoint, wherein the configuration agent is to receive a command from a configuration master of the second endpoint and execute the command to update the configuration data including the buffer limit for enabling or disabling monitoring of the application.

12. The non-transitory computer-readable storage medium of claim 10, wherein instructions to determine the category of the application comprise instructions to:
receive, via a service discovery agent running in the first endpoint, a plurality of applications running in the first endpoint, wherein each application belongs to one of a set of categories, and wherein each category is associated with a different predefined buffer limit;
receive, via the user interface of the monitoring application, a request to add or remove an input plugin configuration for enabling or disabling monitoring of the application from the plurality of applications; and
upon receiving the request, determine the category of the application from the set of categories.

13. The non-transitory computer-readable storage medium of claim 10, wherein instructions to update the configuration data of the monitoring agent comprise instructions to:
in response to the request to enable monitoring of the application, update, via a configuration agent running in the first endpoint, the configuration data to:
add the input plugin configuration to a configuration file of the monitoring agent for monitoring the application; and
add the predefined buffer limit associated with the application to the buffer limit of the monitoring agent.

14. The non-transitory computer-readable storage medium of claim 10, wherein instructions to update the configuration data of the monitoring agent comprise instructions to:
in response to the request to disable monitoring of the application, update, via a configuration agent running in the first endpoint, the configuration data to:
remove the input plugin configuration from a configuration file of the monitoring agent for disabling monitoring of the application; and
deduct the predefined buffer limit associated with the application from the buffer limit of the monitoring agent.

15. The non-transitory computer-readable storage medium of claim 10, wherein instructions to enable the monitoring agent to monitor the first endpoint comprise instructions to:
upon modifying the buffer limit, restart the monitoring agent to enable the monitoring agent to monitor the endpoint based on the updated configuration data.

16. A method performed by a remote collector executing on a management node, comprising:
receiving a first request to install a monitoring agent on an endpoint, the first request comprising an operating system type;
determining a buffer limit based on the operating system type;
installing the monitoring agent with configuration data on the endpoint, the configuration data specifying a configuration to monitor an operating system executing in the endpoint and the buffer limit for the monitoring agent;
receiving a second request to monitor an application running in the endpoint;
determining a category of the application running in the endpoint;
determining a predefined buffer limit associated with the determined category;
updating the configuration data of the monitoring agent to:
add a configuration to enable monitoring of the application; and
update the buffer limit to add the predefined buffer limit; and
enabling the monitoring agent to monitor the operating system and the application based on the updated configuration data.

17. The method of claim 16, further comprising:
upon installing the monitoring agent on the endpoint, executing the monitoring agent to enable monitoring of the operating system based on the configuration data with the buffer limit.

18. The method of claim 16, wherein receiving the second request comprises:
receiving, via a service discovery agent running on the endpoint, a list of applications running in the endpoint, wherein the service discovery agent is to discover the plurality of services running in the endpoint;
rendering the list of the discovered applications on a user interface of a monitoring application; and
receiving, via the user interface of the monitoring application, the second request to monitor the application from the discovered applications.

19. The method of claim 16, wherein updating the configuration data comprises:
initiating, via a configuration agent running in the endpoint, a command to:
add an input plugin configuration to a configuration file of the monitoring agent for enabling monitoring of the application; and
update the buffer limit to add the predefined buffer limit.

20. The method of claim 16, further comprising:
receiving a third request to disable monitoring of the application;
determining the category of the application running in the endpoint;
determining the predefined buffer limit associated with the determined category;
reupdating the configuration data of the monitoring agent to:
remove the configuration to disable monitoring of the application; and
update the buffer limit to deduct the predefined buffer limit; and
enabling the monitoring agent to monitor the operating system based on the reupdated configuration data.
